(19) United States
(12) Patent Application Publication
(10) Pub. No.: US 2021/0027182 A1
(43) Pub. Date: Jan. 28, 2021

(54) AUTOMATED MACHINE LEARNING SYSTEMS AND METHODS

(71) Applicant: Visa International Service Association, San Francisco, CA (US)

(72) Inventors: Theodore Harris, San Francisco, CA (US); Yue Li, San Mateo, CA (US); Tatiana Korolevskaya, Mountain View, CA (US)

(21) Appl. No.: 16/981,246

(22) PCT Filed: Mar. 21, 2018
(86) PCT No.: PCT/US2018/023646

§ 371 Date: Sep. 15, 2020

(51) Int. Cl. G06N 5/04; G06N 5/02; G06K 9/62; G06N 20/00

(52) U.S. Cl. CPC G06N 5/04; G06N 20/00; G06K 9/6264; G06N 5/025

(57) ABSTRACT

A series of algorithms can be applied to an automated machine learning model building process in order to reduce complexity and improve model performance. In addition, the settings and parameters for implementing the automated machine learning model building process can be tuned to improve performance of future models. The model building process can also be monitored to ensure that the current build is based on new information compared to previously builds.

### BACKGROUND

Artificial intelligence and machine learning algorithms have been developed to solve problems that may be difficult or impossible to solve through conventional computer programming. For example, it may not be possible for a software engineer to determine a set of instructions and rules for accurately recognizing written text, detecting spam email, or classifying objects in images when the input data is not constrained. However, machine learning algorithms can solve such problems by building models are that based on a large set of training data. These models may identify patterns and features within the training data that do not have meaning to human software engineers, but that can be used to accurately classify entities, organize data, optimize solutions, and make predictions or decisions.

One constraint on machine learning algorithms is that the models they generate can only perform as well as the training data that they are based on. In addition, different machine learning algorithms have different strengths, weaknesses, and bias, which may lead to poor model performance in certain circumstances. As such, there is a need for improved systems and methods for building machine learning models.

### BRIEF SUMMARY

Embodiments described herein provide a computer system for building machine learning models. The computer system can include a system memory, one or more processors, and a computer readable storage medium. The computer readable storage medium of the computer system can store instructions that, when executed by the one or more processors, cause the one or more processors to perform certain functions for building machine learning models. The computer system can receive a new set of previous requests and results associated with the new set of previous requests. The computer system can also create a topological graph based on the new set of previous requests and a stored set of historical requests. The topological graph can include nodes and edges connecting the nodes. The computer system can also determine a plurality of communities from the topological graph using a community detection algorithm. Each community of the plurality of communities including a subset of the nodes. The computer system can also determine one or more inferred edge connections between the nodes of the topological graph using an optimization algorithm. The one or more inferred edge connections can reduce a cost function based on the results associated with the new set of previous requests and stored results associated with the stored set of historical requests. The computer system can also include the one or more inferred edge connections into the topological graph. The computer system can combine two or more paths of nodes and edges into a single path based on a commonality of the two or more paths to obtained a smoothed topological graph. The computer system can also build a predictive model based on the smoothed topological graph using a supervised machine learning algorithm, the plurality of communities, the results associated with the new set of previous requests, and the stored results associated with the stored set of historical requests. The computer system can also generate a set of binary decision rules using the predictive model and the topological graph. The binary decision rules can set a threshold value for a continuous score determined by the predictive model.

Embodiments described here also provide a method for building machine learning models. The method includes receiving a new set of previous requests and results associated with the new set of previous requests. The method also includes creating a topological graph based on the new set of previous requests and a stored set of historical requests. The topological graph including nodes and edges connecting the nodes. The method also includes determining a plurality of communities from the topological graph using a community detection algorithm. Each community of the plurality of communities including a subset of the nodes. The method also includes determining one or more inferred edge connections between the nodes of the topological graph using an optimization algorithm. The one or more inferred edge connections reducing a cost function based on the results associated with the new set of previous requests and stored results associated with the stored set of historical requests. The method also includes including the one or more inferred edge connections into the topological graph. The method also includes combining two or more paths of nodes and edges into a single path based on a commonality of the two or more paths to obtained a smoothed topological graph. The method also includes building a predictive model based on the smoothed topological graph using a supervised machine learning algorithm, the plurality of communities, the results associated with the new set of previous requests, and the stored results associated with the stored set of historical requests. The method can also include generating a set of binary decision rules using the predictive model and the topological graph. The binary decision rules can set a threshold value for a continuous score determined by the predictive model.

### BRIEF DESCRIPTION OF THE DRAWINGS

FIG. 1 shows an information flow diagram of a method for building and using a machine learning model, in accordance with some embodiments.

FIG. 2 shows an information flow diagram of an automated process for building a machine learning model, in accordance with some embodiments.

FIG. 3 shows a high level illustration of the automated machine learning process of FIG. 2.

FIG. 4 shows a flow chart of a method for optimizing the model building process, in accordance with some embodiments.

FIG. 5 shows a flow chart of a method for monitoring a model building process, in accordance with some embodiments.

FIG. 6 shows a system diagram of an authentication hub in communication with client devices, data processing servers, and resource management computers, in accordance with some embodiments.

FIG. 7 shows a flowchart of an automated process for building a machine learning model, in accordance with some embodiments.

### DETAILED DESCRIPTION

Machine learning refers to the use of artificial intelligence (AI) computer algorithms to build predictive models that can learn and improve through experience. Supervised machine learning algorithms can use sets of labeled data to build models that make predictions for unlabeled input data (e.g., regression analysis, predicting output values from input values or predicting classifications for new input data). Unsupervised machine learning algorithms can use unlabeled data to build models that identify structure, patterns, and relationships among the unlabeled data (e.g., clustering or filtering of input data).

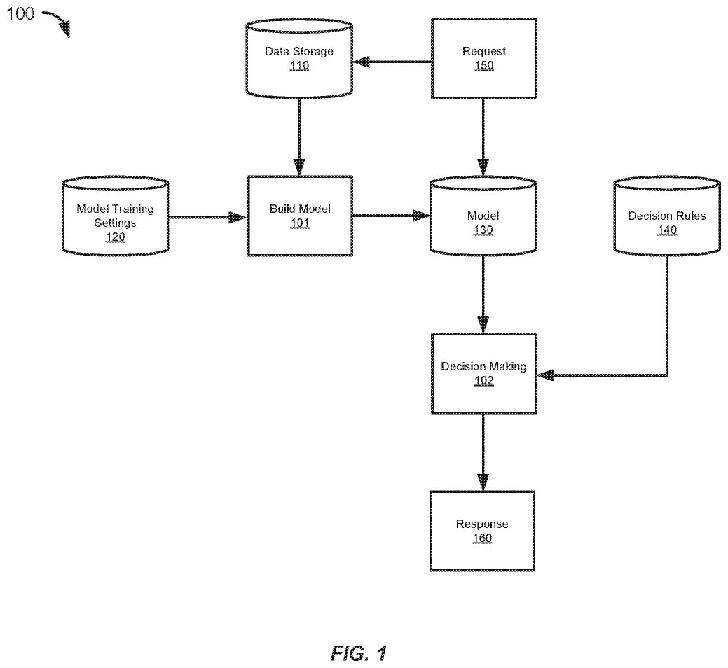

Machine learning algorithms can be used for solve a variety of problems. For example, FIG. 1 shows an information flow diagram 100 of a method for building and using a machine learning model, in accordance with some embodiments. The method can be performed by one or more server computers. A server computer can store data to use for training the machine learning model in data storage 110. The data can contain a plurality of data records or objects. The data storage 110 can also store target/expected output values corresponding to each element of the data.

For example, the data storage 110 can contain a list of websites visited by a particular person the frequency with which the person visits each of the website, and the duration of the visit per website. The browsing histories may be used as training data for a machine learning algorithm in building a model. For example, each person's browsing history may be represented as a vector, where each website is represented as a dimension of the vector and the magnitude of the dimension is based on the corresponding frequency and duration. In another example, the browsing histories may be represented as nodes within a connected topological graph. The data storage 110 can also contain a table indicating the age of each person, which can be associated with their browsing history. From this data, a model can be built to predict a person's age based on their Internet browsing history.

At 101, a supervised machine learning algorithm can be used to build a model 130 based on a training sample selected from among the data records (e.g., browsing histories) stored in the data storage 110 and their corresponding output values (e.g., the corresponding person's age). The building (e.g., training) of the model can involve an iterative process of updating the model in order to minimize a loss function that quantifies the difference between the model's prediction and the target output values. As such, the machine learning algorithm “learns” how to make better predictions over successive iterations. Various different machine learning techniques, having different model structures and training methods, can be used to build the model 130. For example, the model 130 can be built using linear regression, nearest neighbor, gradient boosting, or neural network algorithms. Once the model 130 is built, it can be validated using the records stored in the data storage 130.

The model 130 can be built according to various predetermined model training settings 120 that control various parameters of the machine learning process. The model training settings 120 can include settings for selecting and shuffling the training data (e.g., different sampling methods), parameters for modifying the data (e.g., normalizing or weighting certain aspects of the data), settings to indicate which type of machine learning algorithm will be used to train the model 130, a parameter to set a maximum model size (e.g., in bytes), a parameter to limit the number of iterations or passes performed by the machine learning algorithm, and parameters to set initial weights or variables used by the particular machine learning algorithm. The predetermined model training settings 120 may be determined through experimentation or research.

After building and validating the model 130, it can be used to make predictions on new data where the target output is unknown. For instance, a server storing the model 130 can receive a request 150 including an unknown person's Internet browsing history and it can make a prediction of the person's age. The server can then make a decision based on the person's age. To do this, the server can input a set of data based on the record into the model 130, which determines a predicted output value. For example, the model 130 can predict a person's age based on their Internet browsing history as discussed above. The request 150 can also be stored in the data storage 110 such that it could potentially be used for training later builds of the model.

While the model 130 can determine a predicted output value, the predicted output value may not be particularly useful in of itself. Accordingly, in addition to running the input data through the model 130, the server can perform decision making, at 102, by applying the predicted output value to a set of decision rules 140. For example, where the model predicts a person's age based on their browsing history, the decision making process at 102 can determine which age range a person falls into based on thresholds established by the decision rules 140 and then generate a response 160 based on the age range of the person. For example, the response 160 could include a different webpage based on the decision rules 140 and the age range of the person.

One limitation of the model 130 is that it can become outdated and less accurate over time. For instance, in the example above, people of different ages may start to visit different webpages over time, causing the model to not be able to accurately predict a person's age anymore. Accordingly, more training data may be accumulated to account for the change, which can lead to more accurate model builds.

In some embodiments, the model can be rebuilt at scheduled intervals (e.g., every week or every 6 months). To do this, the server can collect new records in the data storage 110 along with corresponding target output values for the records. In the example above, each new request 150 (e.g., containing an Internet browsing history) can be stored in the data storage 110 and the people associated with the request can be polled (e.g., by telephone) to determine their age (e.g., the expected value for the model), which can then be associated with their browsing history record. Then the updated collection of records can be sampled to rebuild the model 130.

While rebuilding the model at set intervals can prevent it from becoming outdated, this process has several disadvantages. One disadvantage is that rebuilding the model can require a significant amount of computing resources (e.g., processing power and memory usage) to be expended, especially if the model is rebuilt frequently and if it is based on larger amounts of training data. In addition, rebuilding the model numerous times may cause the model to become overfit to the problem (e.g. the model corresponds too closely to the training data, causing it to fail to accurately predict future input data). Also, certain model rebuilding processes may not update the corresponding decision rules 140 or the decision making logic at 102. Thus, even if the accuracy of the rebuilt model is improved, the responses generated by the server may become less useful since the thresholds and ranges used in the decision making process 102 are no longer suited to the output of the model 130. In addition, certain model rebuilding processes may continue to use the same model training settings 120 for each rebuild of the model. However, the initial parameters and weighting factors designated by the model training settings 120 may no longer be appropriate for the updated training data.

The improved systems and methods for generating machine learning models described below address these problems by using a series of algorithms to improve the training data prior to building the model and by providing an automated evolutionary learner that monitors and tunes the model building process based on feedback from the algorithms, thereby improving model performance. For instance, the accuracy of the model predictions can be improved by detecting and inferring community structures within the training data. In addition, the information space (e.g., a graph structure) for building the model can be smoothed to reduce complexity and misinformation. Furthermore, the outcomes of previous model rebuilds can be monitored and an evolutionary learner can automatically tune the settings and parameters used in later model building processes based on the outcomes of prior model building processes. The training data can also be monitored to determine whether new data is different enough to require the model to be rebuilt. Thus, the improved systems and methods for generating machine learning models described below can provide more accurate models and decision making while reducing the amount of computer resources used in maintaining and rebuilding.

### I. Terms

Explanation and description of certain terms and phrases used in the Detailed Description are provided below.

An “artificial intelligence” (AI) algorithm may include an algorithm that is associated with tasks that normally require human intelligence. Examples of artificial intelligence algorithms may include refer to a graph learner (e.g., restricted Boltzmann Machine, or K-means clustering, etc.), search optimization algorithms (e.g., Ant Colony), scoring algorithms (e.g., an artificial neural network or vector distance model), machine learning algorithms, or a combination of more than one algorithm. An AI algorithm may also refer to the use of a behavior tree to determine one or more actions based on output from any, or a combination of, the AI algorithms mentioned above.

A “machine learning algorithm” or “learner” generally refer to an artificial intelligence process that creates a model or structure that can be used to identify patterns, make decisions, or make predications. For example, predictions can be generated by applying input data to a predictive model formed from performing statistical analysis on aggregated data. A clustering algorithm is an example of a machine learning algorithm. A predictive model can be trained using training data, such that the model may be used to make accurate predictions. The prediction can be, for example, a classification of an image (e.g. identifying objects in images) or as another example, a recommendation (e.g. a decision). Training data may be collected as existing records. Existing records can be any data from which patterns can be determined from. These patterns may then be applied to new data at a later point in time to make a prediction. Existing records may be, for example, user data collected over a network, such as user browser history or user spending history. Existing records may be used as training data for building or training of a machine learning model. The model may be a statistical model or predictive model, which can be used to predict unknown information from known information.

For example, the learning module may be a set of instructions for generating a regression line from training data (supervised learning) or a set of instructions for grouping data into clusters of different classifications of data based on similarity, connectivity, and/or distance between data points (unsupervised learning). The regression line or data clusters can then be used as a model for predicting unknown information from known information. Once the model has been built from the learning module, the model may be used to generate a predicted output from a new request. The new request may be for a prediction associated with input data included in the request.

“Supervised machine learning” generally refers to machine learning algorithms that use a set of labeled data associated with the training samples. The labeled data indicates the expected or desired output (e.g., result) for a given input. For example, images can be labeled with the objects contained therein and a supervised machine learning algorithm can create a model structured to identify and classify new unlabeled images accordingly. As another example, a set of emails can be tagged as “spam” or “not-spam” and a supervised machine learning algorithm can build a model to determine whether a new unlabeled email is spam or not-spam. As another example, a continuous score can be predicted based on a set of input variables using a model that was built based on known input and out values.

“Unsupervised machine learning” generally refers to learning algorithms that do not use information or labels regarding an expected or desired result. Unsupervised machine learning algorithms may create models or structures that identify features and patterns within the training sample. For example, an unsupervised machine learning algorithm may identify clusters of similar samples (e.g., communities) within the training sample, without requiring a human-defined label for such groups.

A “request message” generally refers to a communication sent to a “server computer” requesting information or requesting a particular action to be performed. For example, the request could contain information to be input into a machine learning model and the request could be a request to receive a predictive output from the machine learning model for that input. The request message may be received from a “client device.”

A “response message” generally refers to a communication sent from a server computer. The response message may be sent in response to a request message. The response message may be sent to a client device. The response message may include the requested information or it indicate whether the requested action was performed or not.

A “topological graph” may refer to a representation of a graph in a plane of distinct vertices connected by edges. The distinct vertices in a topological graph may be referred to as “nodes.” Each node may represent specific information for an event or may represent specific information for a profile of an entity or object. The nodes may be related to one another by a set of edges, E. An “edge” may be described as an unordered pair composed of two nodes as a subset of the graph G=(V, E), where is G is a graph comprising a set V of vertices (nodes) connected by a set of edges E. An edge may be associated with a numerical value, referred to as a “weight” or “distance,” assigned to the pairwise connection between the two nodes. The edge weight may be identified as a strength of connectivity between two nodes and/or may be related to a cost or distance, as it often represents a quantity that is required to move from one node to the next. In the drawings, nodes may be represented as circles, and edges may be represented as lines between the nodes.

The term “information space” may refer to a set of data that may be explored to identify specific data to be used in training a machine learning model. The information space may be represented as a topological graph or another structure. The information space may comprise data relating to events, such as the time and place that the events occurred, the devices involved, and the specific actions performed, parameters or settings for the actions performed, etc. An involved device may be identified by an identification number and may further be associated with a user or entity. The user or entity may be associated with profile data regarding the user or entity's behavior and characteristics. The data may further be characterized as comprising input and output variables, which may be recorded and learned from in order to make predictions.

A “feature” may refer to a specific set of data to be used in training a machine learning model. An input feature may be data that is compiled and expressed in a form that may be accepted and used to train an artificial intelligence model as useful information for making predictions. An input feature may be identified as a collection of one or more input nodes in a graph, such as a path comprising the input nodes.

A “community” may refer to a group/collection of nodes in a graph that are densely connected within the group. A community may be a subgraph or a portion/derivative thereof and a subgraph may or may not be a community and/or comprise one or more communities. A community may be identified from a graph using a graph learning algorithm, such as a graph learning algorithm for mapping protein complexes. Communities may also be identifier using a K-means algorithm. Communities identified using historical data can be used to classify new data for making predictions. For example, identifying communities can be used as part of a machine learning process, in which predictions about information elements can be made based on their relation to one another.

A “data set” may refer to a collection of related sets of information composed of separate elements that can be manipulated as a unit by a computer. A data set may comprise known data, which may be seen as past data or “historical data.” Data that is yet to be collected, may be referred to as future data or “unknown data.” When future data is received at a later point it time and recorded, it can be referred to as “new known data” or “recently known” data, and can be combined with initial known data to form a larger history.

“Authentication information” may be information that can be used to authenticate a user or a client device. That is, the authentication information may be used to verify the identity of the user or the client device. In some embodiments, the user may input the authentication information into a device during an authentication process. Examples of authentication information that can be input by a user of the client device include biometric data (e.g., fingerprint data, facial recognition data, 3-D body structure data, deoxyribonucleic acid (DNA) data, palm print data, hand geometry data, retinal recognition data, iris recognition data, voice recognition data, etc.), passwords, passcodes, personal identifiers (e.g., government issued licenses or identifying documents), personal information (e.g., address, birthdate, mother's maiden name, or phone number), and other secret information (e.g., answers to security questions). Authentication information can also include data provided by the device itself, such as hardware identifiers (e.g., an International Mobile Equipment Identity (IMEI) number or a serial number), a network address (e.g., internet protocol (IP) address), interaction information, and Global Positioning System (GPS) location information).

The term “agent” or “solver” may refer to a computational component that searches for a solution. For example, one or more agents may be used to calculate a solution to an optimization problem. A plurality of agents that work together to solve a given problem, such as in the case of ant colony optimization algorithm, may be referred to as a “colony.”

The term “epoch” may refer to a period of time, e.g., in training a machine learning model. During training of learners in a learning algorithm, each epoch may pass after a defined set of steps have been completed. For example, in ant colony optimization, each epoch may pass after all computational agents have found solutions and have calculated the cost of their solutions. In an iterative algorithm, an epoch may include an iteration or multiple iterations of updating a model. An epoch may sometimes be referred to as a “cycle.”

A “trial solution” may refer to a solution found at a given cycle of an iterative algorithm that may be evaluated. For example, in the ant colony optimization algorithm, a trial solution may refer to a solution that is proposed to be a candidate for the optimal path within an information space before being evaluated against predetermined criteria. A trial solution may also be referred to as a “candidate solution,” “intermediate solution,” or “proposed solution.” A set of trial solutions determined by a colony of agents may be referred to as a solution state.

A “client device” or “user device” may include any device that can be operated by a user. A client device or user device can provide electronic communication with one or more computers. A communication device can be referred to as a mobile device if the mobile device has the ability to communicate data portably. A “mobile device” may comprise any suitable electronic device that may be transported and operated by a user, which may also provide remote communication capabilities over a network. Examples of remote communication capabilities include using a mobile phone (wireless) network, wireless data network (e.g. 3G, 4G or similar networks), Wi-Fi, Wi-Max, or any other communication medium that may provide access to a network such as the Internet or a private network. Examples of mobile devices include mobile phones (e.g. cellular phones), PDAs, tablet computers, net books, laptop computers, personal music players, hand-held specialized readers, etc. Further examples of mobile devices include wearable devices, such as smart watches, fitness bands, ankle bracelets, etc., as well as automobiles with remote communication capabilities. A mobile device may comprise any suitable hardware and software for performing such functions, and may also include multiple devices or components (e.g. when a device has remote access to a network by tethering to another device—i.e. using the other device as a modem—both devices taken together may be considered a single mobile device). A mobile device may further comprise means for determining/generating location data. For example, a mobile device may comprise means for communicating with a global positioning system (e.g. GPS).

A “server computer” may include any suitable computer that can provide communications to other computers and receive communications from other computers. Use of the term “server computer” may refer to a cluster or system of computers. For instance, a server computer can be a mainframe, a minicomputer cluster, or a group of servers functioning as a unit. In one example, a server computer may be a database server coupled to a Web server. A server computer may be coupled to a database and may include any hardware, software, other logic, or combination of the preceding for servicing the requests from one or more client computers. A server computer may comprise one or more computational apparatuses and may use any of a variety of computing structures, arrangements, and compilations for servicing the requests from one or more client computers. Data transfer and other communications between components such as computers may occur via any suitable wired or wireless network, such as the Internet or private networks.

A “resource manager” can be any entity that provides resources. Examples of a resource managers include a website operator, a data storage provider, an internet service provider, a merchant, a bank, a building owner, a governmental entity, etc. Any entity that maintains accounts for users or that can provide information, data, or physical objects to users may be considered a “resource manager.” A resource manager computer may process requests from client devices, thereby operating as a server computer.

An “access device” may be any suitable device that provides access to a remote system. An access device may also be used for communicating with a resource management computer, a merchant computer, a transaction processing computer, an authentication computer, or any other suitable system. An access device may generally be located in any suitable location, such as at the location of a merchant. An access device may be in any suitable form. Some examples of access devices include POS or point of sale devices (e.g., POS terminals), cellular phones, PDAs, personal computers (PCs), tablet PCs, hand-held specialized readers, set-top boxes, electronic cash registers (ECRs), automated teller machines (ATMs), virtual cash registers (VCRs), kiosks, security systems, access systems, and the like. An access device may use any suitable contact or contactless mode of operation to send or receive data from, or associated with, a user mobile device. In some embodiments, where an access device may comprise a POS terminal, any suitable POS terminal may be used and may include a reader, a processor, and a computer-readable medium. A reader may include any suitable contact or contactless mode of operation. For example, exemplary card readers can include radio frequency (RF) antennas, optical scanners, bar code readers, or magnetic stripe readers to interact with a payment device and/or mobile device. In some embodiments, a cellular phone, tablet, or other dedicated wireless device used as a POS terminal may be referred to as a mobile point of sale or an “mPOS” terminal.

An “application” may be computer code or other data stored on a computer readable medium (e.g. memory element or secure element) that may be executable by a processor to complete a task.

A “message” can refer to any type of communication between any of the computers, networks, and devices described herein. Messages may be communicated between devices coupled together, or they may be transmitted across a network. Messages may be transmitted using a communications protocol such as, but not limited to, File Transfer Protocol (FTP); HyperText Transfer Protocol (HTTP); Secure Hypertext Transfer Protocol (HTTPS), Secure Socket Layer (SSL), ISO (e.g., ISO 8583) and/or the like.

### II. Automated Machine Learning

The embodiments described herein provide improved systems and methods for generating machine learning models using a series of artificial intelligence (AI) and machine learning algorithms. The series of artificial intelligence algorithms can modify the training data prior to building the model. Each step of the automated machine learning process may reduce complexity in order to make the next step in the process more efficient. These algorithms can be driven and controlled by a modeling behavior tree that initializes and runs each of the algorithms. The modeling behavior tree that drives the model building process can be tuned by an optimization behavior tree based on an evaluation of the performance of the model. Thus, the machine learning model building process is “automated” because the modeling behavior tree is used to monitor new training data and drive the model building process. In addition, the tuning (e.g., updating) of the model building process is also optimized because the optimization behavior tree is used to evaluate and modify the modeling behavior tree. As such the framework of the model building process is continuously and automatically improved through evaluation and optimization of the modeling behavior tree by the optimization behavior tree, thereby providing improving later rebuilds of the model. This automatic self-correction enables the model to maintain its accuracy should characteristics of the training data shift overtime.

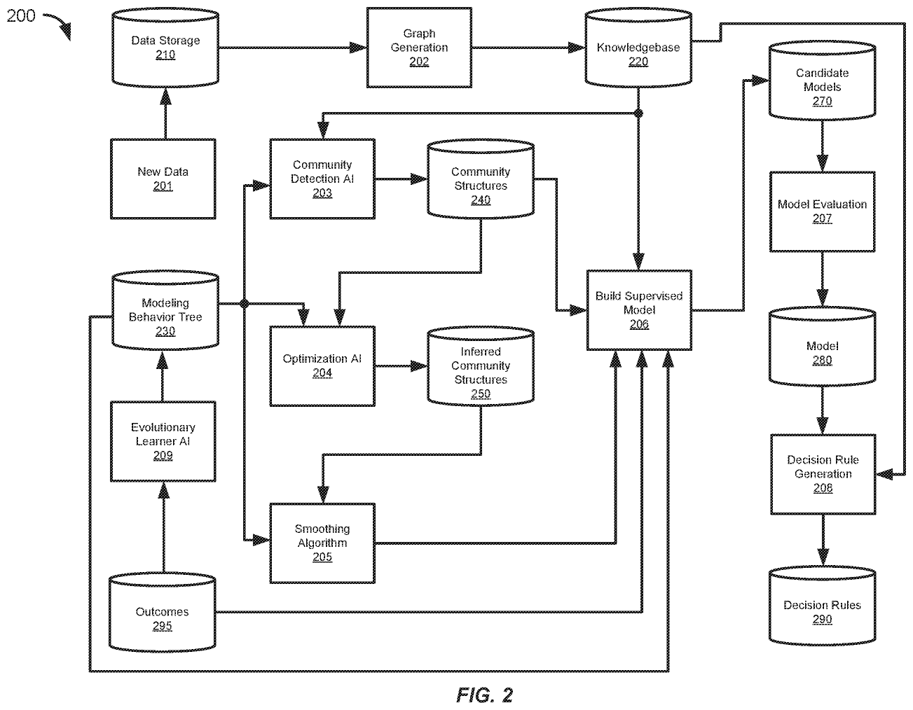

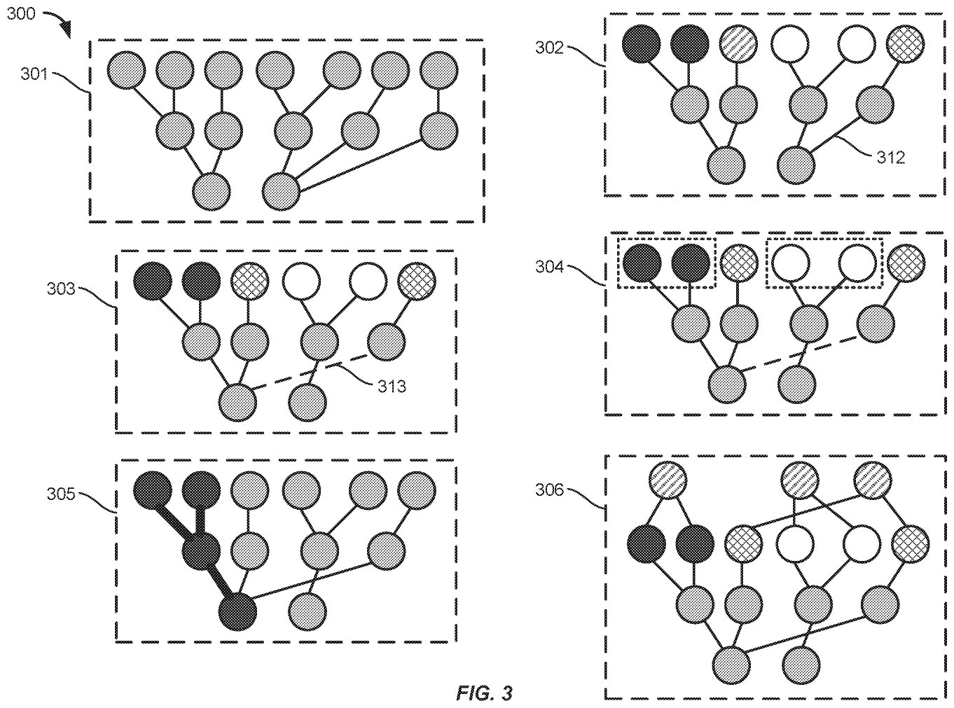

FIG. 2 shows an information flow diagram 200 of an automated process for building a machine learning model 280, in accordance with some embodiments. Certain steps of the automated machine learning process of FIG. 2 can be illustrated as a series of graphs. FIG. 3 shows a high level illustration of the automated machine learning process of FIG. 2. The automated machine learning process may be performed by a computer system for building machine learning models. The computer system may include one or more server computers and storage databases. The server computer may include a system memory, one or more processors, and a computer readable storage medium. The computer readable medium may store instructions that, when executed by the one or more processors, cause the one or more processors to perform the automated machine learning process described herein.

The model building process combines several different machine learning algorithms in order to offset the weaknesses and bias inherent in the individual algorithms. In addition, the model building process is driven and controlled by a modeling behavior tree 230 that defines both the overall data processing settings (e.g., time frames, signal to noise ratios, etc.) and the settings and parameters for each of the machine learning algorithms (e.g., initialization conditions, choice parameter, cut off values, and number of iterations). The modeling behavior tree 230 can then be tuned, by an optimization behavior tree, using a feedback loop based on the outcomes of the machine learning algorithms, thereby improving the model building process for later rebuilds.

A. Training Data

The automated machine learning process can be performed by a server computer or a cluster of server computers. The server computer can store training data to use for training the machine learning model in data storage 210. The training data can contain a plurality of requests, data records, data objects, or other information. For example, the training data can include a stored set of historical requests that can be supplemented with a new set of previous requests. The new set of previous requests may have been made more recently in time compared to the historical requests. The new and historical requests being requests may have made to an operational response system (e.g., a server computer implementing a model for decision making). The new and historical requests may be stored to be used as training data for models builds.

The data storage 210 can also store results (e.g., labels or target/expected output values) associated with the new and historical request. For example, a machine learning model for detecting suspicious device behavior can store records of messages and requests from various devices and labels of whether these records were sent by a device that had its security breached. In another example, a fraud detection model can be built based on a plurality of previous authentication requests (e.g., email login request) for access to resources (e.g., email inbox) where the authentication requests are labeled as being fraudulent or not-fraudulent.

The server computer can also receive a new set of previous requests and results associated with the new set of previous requests, at 201. Accordingly, the training data can be updated over time. The new set of previous requests and the results associated with the new set of previous requests can be stored in a data storage 210 (e.g., a database, table, etc.).

For example, the new set of previous requests can be authentication requests made to an authentication server that uses a model to determine whether the authentication request is fraudulent or not-fraudulent. In this example, the results associated with the new set of previous requests may be a scoring-value determine by the model for the corresponding request. The results associated with the new set of previous requests may also include a label or “fraudulent” or “not-fraudulent” for the corresponding authentication request. The new set of previous requests may be “new” in the sense that these requests were made (e.g., to the server computer operating the model) in the last six months, for example. In contrast, the currently stored set of “historical” requests may include requests that were made within the past eighteen months or two years, for example. The training data for training the model can be based on both the new set of previous requests and the stored set of historical requests to ensure that the model is up to date with trending parameters and characteristics of the requests.

B. Topological Graph Generation

At 202, the server computer can create a topological graph based on the new set of previous requests and the stored set of historical requests (e.g., stored in the data storage 210). The topological graph can include nodes and edges connecting the nodes. The nodes may represent characteristics or parameters of the requests and the edges representing relationships between the nodes. The topological graph, and previously created topological graphs, can be stored in a knowledgebase 220. The first graph 301 of FIG. 3 illustrates the training data expressed as a topological graph.

In some embodiments, the topological graph can be created based on a training sample of the new and historical requests stored in the data storage 210. The sample can be selected from the stored requests randomly, or using a formula or algorithm. The server computer may also determine a hold out sample to use for validating the resulting model built based on the training sample.

In some embodiments, certain fields and parameters of a request can be represented as a node in the graph and related nodes may be connected by edges. The nodes of the topological graph may be connected to one another via edges that represent the relationship/linkage between nodes. Nodes related to the same request can be connected to each other by edges. For example, a node for an IP address of a device may be connected to a node for a hardware identifier of that specific device. The IP address may also be connected to a node for a geolocation associated with that IP address. In one example, where the requests are authentication request, nodes in the topological graph may represent a time that the authentication request was sent, a particular resource manager identifier associated with the request, resource manager type of the particular resource manager, an IP address used in sending the authentication request, a device identifier of a device used to make the request, etc.

Each edge may be associated with a weight quantifying the interaction between the two nodes of the edge. The edge-weights may be related to vector distances between nodes, as the position of two nodes relative to one another can be expressed as vector in which edges between nodes have a specific length quantifying their relationship. For example, the relationship between two nodes can either be measured as a weight in which higher correlations are given by higher weights, or, the relationship can be measured as a distance, in which higher correlations are given by shorter distances. In the latter case, highly connected nodes that interact frequently with each other may be densely populated in the graph (i.e. close to one another within a distinct region of the graph). For example, node associated with a first IP address used more often by a device may have a higher edge weight to a node associated with the hardware identifier of the device compared to a node associated with a second IP address that is used less often by the device. Thus, the length of an edge can be inversely proportional to its edge-weight. In some embodiments, the nodes may be represented as a multi-dimensional vector (e.g., magnitudes and directions) and edge weights may be based on a vector distance between nodes.

C. Community Detection Algorithm

After the creation of the topological graph, the server computer can determine a plurality of communities from the topological graph using a community detection algorithm 203. Each community of the plurality of communities can include a subset of the nodes. The plurality of communities can be stored in a community structure database 240. The second graph 302 of FIG. 3 illustrates the community structures within the topological graph.

The community detection algorithm could be one of various algorithms suited for this purpose. For example, the community detection algorithm could be the K-means algorithm, a restricted Boltzmann machine (RMB), an identifying protein complexes algorithm (IPCA), or a hyper IPCA algorithm. Further details relating to the K-means algorithm, including variations and extensions thereof, are described in Huang, Zhexue. “Extensions to the k-Means Algorithm for Clustering Large Data Sets with Categorical Values.” Data Mining and Knowledge Discovery 2, 1998, pp. 283-304. Further details relating to restricted Boltzmann machines, including training and variations thereof, are described in Fischer, Asja. “Training Restricted Boltzmann Machines: An Introduction.” Pattern Recognition, Volume 47, Issue 1, 2014, pp. 25-39. Further details relating to the identifying protein complexes algorithm are described in Li, Min. “Modifying the DPClus Algorithm for Identifying Protein Complexes Based on New Topological Structures.” BMC Bioinformatics, 2008, 9. 398. 10.1186/1471-2105-9-398. Further details relating to the hyper IPCA algorithms are described in International patent application no. PCT/US2018/014550, “Data Security Using Graph Communities,” filed Jan. 19, 2018.

The communities of the community structures 204 may contain groups of nodes that are highly connected (as given by greater weights and shorter distances), indicating that they have a high probability of interacting with one another. The community structures 204 can indicate which nodes as associated with which communities. Furthermore, communities may overlap (e.g., nodes can belong to more than one community). In addition, the community detection algorithm can remove weak structures and relationships from the topological graph. In some embodiments, the community structures can be determined using a weighted average of the training data where more recent data is weighted more than older data such that new trends are more prominent.

The modeling behavior tree 230 can determine which type of community detection algorithm to use (e.g., K-means, restricted Boltzmann machine, or IPCA) and the settings and parameters for running the selected community detection algorithm. For example, the modeling behavior tree 230 can set the ‘K’ value (number of clusters) for running the K-means algorithm. The modeling behavior tree 230 can also determine the method for determine distance when performing community detection (e.g., smallest sum of squares, smallest maximum distance, etc.). The modeling behavior tree can also set the weights and bias factors used in the community detection algorithm. Further details relating to behavior trees, and variations and extensions thereof, are described in Winter, Kirsten. “Formalising Behaviour Trees with CSP.” LNCS, vol. 2999, 2004, pp. 148-167. Further details relating to behavior trees are also described in Shoulson, Alexander. “Parameterizing Behavior Trees.” Motion in Games, 2011, pp. 144-155.

In one embodiment, the communities can be determined based on a vector distance between the nodes in the topological graph. The request can be vectorized and the community structures can be determined based on the vector distances between nodes being below a similarity threshold, where a lower similarity threshold would result in fewer predicted communities and a higher similarity threshold would result in more predicted communities

In another embodiment, IPCA, or hyper IPCA (e.g., a hyper graph implementation of IPCA) may be used to form the communities. Each distinct community may comprise densely populated nodes that interact more frequently with one another than with nodes of a different community. Each community that is to be created may originate from a seed node. The seed node may serve as a first node in a community that is being generated, and the community may be further built by extending the community from the first node to the closest node based on whether or not the node meet predefined criteria. Once all remaining neighbors of the community fail to meet the predefined criteria, then the community cannot be further extended, and the nodes of community may be completely determined.

In some embodiments, the model building process can end if the underlying data has not changed, thereby preventing the model from becoming overfit. For example, the server computer can determine whether the plurality of communities are different from a stored plurality of communities associated with a stored model. The difference can be based on a similarity threshold value. The stored model may be one of the models that was previously built by the server computer. The next step in the model building process, the determination of one or more inferred edge connections, may be performed based on the determination that the plurality of communities are different from the stored plurality of communities. If the plurality of communities are not different, the model building process can be stopped until new requests are received. Thus, the model is not built unless there is new information, thereby conserving computing resources and preventing the model from becoming overfit.

D. Optimization Algorithm

After determining the community structures 240, the server computer can determine one or more inferred edge connections between the nodes of the topological graph using an optimization algorithm. The one or more inferred edge connections can reduce a cost function based on the results associated with the new set of previous requests and stored results associated with the stored set of historical requests. The one or more inferred edge connections can also be stored in an inferred community structures database 250. In some embodiments, the one or more inferred edge connections may be validated based on the training data. The server computer can include the one or more inferred edge connections into the topological graph. In addition, the optimization algorithm may remove (e.g., prune) existing structures that have weaker relationships (e.g., nodes connected by edging have a weight less than a threshold or a distance greater than a threshold). The third graph 303 of FIG. 3 shows the topological graph with novel structures added (e.g., inferred edge 313) and weak structures removed (e.g., edge 312 of the second graph 302).

The optimization algorithm can initialize a plurality of agents across the topological graph to use in determining the one or more inferred edges. In some embodiments, each individual agent initially starts at a particular node. Each individual agent may begin their search for a path towards the solution, taking its own individual path based on the feedback from other agents as well as statistical probability, which may introduce a degree of randomness to the search.

The agents may explore the topological graph and may communicate path information to the other agents. The path information may comprise cost information. Least costly paths, based on a cost function, may be reinforced as approaching an optimal path. An inferred edge (shown as a dotted line) may be determined from the path information. The inferred edge may be a connection between two nodes for which path information indicates a relationship may exist, despite the lack of any factual edge representing the relationship. The inferred edge may allow for a shorter path between an initial point and the target goal. The agents may be more likely to follow the path in which the shared cost information is lower. This may lead the agents to reach the target goal at a faster pace, and finalize their solution search at the optimal path (e.g., a shorter path to the predefined solution based on the cost function).

Optimal paths (e.g., inferred edge connections) may be determined based on a cost function or goal function, such as a signal-to-noise criteria. An example of a signal-to-noise criteria may be, for example, a ratio of the number of fraudulent authentication requests to non-fraudulent authentication requests for given inputs in a detected path. The cost function can be based on the training data and their corresponding results. A gradient may describe whether the cost function was successfully decreased for each of the respective paths determined by each of the agents and may describe the error between the identified paths and the target goal. If a proposed path has been determined to have reduced the cost function, then the path can be encouraged at the next epoch of the solution search, with the goal being to approach a global optimal path (i.e. shortest or least costly path within the information space to reach the specified goal). In this manner, new features may be added to the graph, in the form of newly inferred connections between input nodes and output nodes. These agents may be run as different processes by a computer system.

The overall path that is taken by the agents when finding a solution can be determined based on the error structure (e.g., gradient) of the information space in relation to the target goal. A random search may be performed by the agents, with each of the agents initialized within a given domain of the information space. Each of the agents may then move from their initial point and begin simultaneously evaluating the surrounding nodes to search for a solution. The agents may then determine a path and may determine the cost of the path and compare it to a predetermined cost requirement. The agents may continuously calculate the cost of their determined paths until their chosen path has met the predetermined cost requirement. The agents may then begin to converge to a solution and may communicate the error of the chosen solution in relation to the target goal. The agents may update a global feedback level, indicating the error gradient, for a path. The global feedback level may be used to bias the distribution of the agents towards a globally optimal solution at the start of each iteration (e.g. by weighting the distribution of agents towards low error regions of the graph). The agents may then repeat the statistically randomized search until the global optimum has been found or the goal has been sufficiently met within a margin of error.

As discussed above, the optimization algorithm can find connections between information that exists in reality, but that is not shown in the data itself. In one example, the topological graph can be built based on authentication requests and the optimization algorithm can be used to detect authentication requests having spoofed or scrambled IP address. For example, a particular authentication request could be coming from Bangalore, India (which may have a higher percentage of fraudulent requests) but may have a spoofed IP address associated with Fresno, Calif. (which may have a lower percentage of fraudulent requests). The optimization algorithm can determine that most of the data for this particular authentication request is within a community for Bangalore, India, except for the IP address.

The optimization algorithm can use a cost function that is based on whether the information associated with a path indicates fraud based on the results associated with the new set of previous requests and the stored results associated with the stored set of historical requests. The optimization algorithm can infer that the particular authentication request should be associated with Bangalore instead and may create an inferred edge between the nodes. Thus, the true community of the authentication request can be inferred and the particular request can be connected to nodes of that community by an inferred edge (e.g., an inferred edge connection to a node corresponding to Bangalore). In some circumstances, an existing edge may be removed without adding an inferred edge, thereby smoothing the graph. For example, the edge connecting the particular authentication request to Fresno may be removed.

One example of an optimization algorithm is the Ant Colony optimization algorithm. Ant colony optimization is a method for finding optimal solutions utilizing the probabilistic technique of simulated annealing to approximate a global optimum solution. The Ant Colony optimization algorithm uses multiple agents to find an optimal solution. Each of the agents communicates feedback to one another. The feedback is recorded and may relay information at each iteration about the effectiveness (e.g., a gradient or other error term) of their respective solution paths relative to the overall goal. The agents may be spread out amongst the entire topological graph structure (e.g., the information space of the optimization algorithm) and may communicate with all agents. Thus, Ant Colony optimization may find solutions that are globally optimal, despite there being a local optimum. For example, the agents in the Ant Colony optimization algorithm may search for a path according to signal-to-noise, shortest path, smoothest topology, etc. Further details relating to the ant colony optimization algorithm are described in Blum, Christian. “Ant Colony Optimization: Introduction and Recent Trends.” Physics of Life Reviews, vol. 2,2005, pp. 353-373.

The modeling behavior tree 230 can be used to control the operation of the optimization algorithm. For example, the modeling behavior tree 230 can determine which node that the agents will start their search from, the number of agents to be used, the number of search iterations, the degree of randomness in the search, the weighting applied to feedback from other agents, etc.

E. Smoothing Algorithm

After the optimization algorithm 204 has determined the inferred community structures, the server computer can combine two or more paths of nodes and edges into a single path based on a commonality of the two or more paths to obtained a smoothed topological graph. A smoothing algorithm 205 (e.g., an artificial neural network (ANN), or a simpler algorithm, such as vector distance) can be used to smooth the topological graph. The smoothing algorithm may combine (e.g., bin together) two or more paths of nodes and edges into a single path based on a commonality of the two or more paths to obtained a smoothed topological graph. Further details relating to artificial neural networks are described in R. Lippmann, “An Introduction to Computing with Neural Nets.” IEEE ASSP Magazine, Apr. 1987, pp. 4-22.

In some embodiments, the smoothing algorithm may determine a commonality between paths by creating continuous scores based off of a predetermined target (e.g., a target set by the modeling behavior tree) and the created features within the structure of the topological graph, thereby smoothing the graph prior to modeling. The AI learner can also validate the novel structures created by the optimization algorithm. The smoothing algorithm 205 can be controlled by the modeling behavior tree 230. For example, the modeling behavior tree 230 can set thresholds for combining nodes and paths. In some embodiments, the commonality between the two or more paths can be determined based on a difference between the total edge-weights (e.g., the distance) along the two or more paths being within a predetermined threshold. In some embodiments, each path of the two or more paths can be treated as a separate graphs and the commonality between the paths can be determined as a graph similarity measure. Further details relating to graph similarity measures, including various methods for calculating them, are described in L. Zager, “Graph Similarity Scoring and Matching.” Applied Mathematics Letters, Vol. 21 Issue 1, January 2008, pp. 86-94.

The fourth graph 304 shows a smoothed topological graph with certain nodes being combined (indicated by the dashed boxes). By smoothing the graph, the information space becomes less firm, reducing or preventing the resulting modeling from being overfit to the training data.

The smoothing algorithm 205 may evaluate multiple paths of nodes in the topological graph together for the strength of their connections, which may give a probability of the nodes being common or being predictive of the same behavior. The strengths of the connections may be provided by the optimization technique used (e.g. ant colony optimization), which may imply inferred edges of a given weight. The inferred edges may be discovered through optimization, and may be of short distances, implying a strong connection between nodes that may have otherwise have been seen as disconnected and/or distant from one another. Once the commonality between sets of nodes has been discovered, it may be determined that they make up paths representing common information, and may thus be combined into a single feature. Smoothing the topological graph can reduce the complexity of the topological graph structure, potentially causing the following machine learning algorithm to use less computing resources in building the model. This advantage may become more prominent when multiple candidate models 280 are built.

In some embodiments, the model building process can end if the underlying data has not changed, thereby preventing the model from becoming overfit. For example, the server computer can determine that the smoothed topological graph is different from a stored topological graph associated with a stored model. The difference can be based on a similarity threshold value. The stored topological graph may be one of the topological graphs used in building a model that was previously built by the server computer. The stored topological graph may have been smoothed and may include inferred edges as discussed above. The next step in the model building process, the building of the model itself, may be performed based on the determination that the smoothed topological graph is different from the stored topological graph. If the smoothed topological graph is not different, the model building process can be stopped until new requests are received.

F. Machine Learning Model

After the topological graph has been smoothed, the server computer can build a predictive model 280 based on the smoothed topological graph using a supervised machine learning algorithm, the plurality of communities, the results associated with the new set of previous requests, and the stored results associated with the stored set of historical requests, at 206. The supervised machine learning algorithm could be a gradient boosting machine or an artificial neural network, for example. For example, when using gradient boosting, an ensemble of weak learners (e.g., decision trees) can be combined in order to create an accurate predictive model.

In some embodiments, several candidate models 270 are built and evaluated, at 207. The server computer can build a plurality of candidate models based on based on the new set of previous requests and the stored set of historical requests using the supervised machine learning algorithm. The plurality of candidate models can include the predictive model. The plurality of candidate models can be built by the modeling behavior tree using different algorithms and different settings and parameters for the different candidate models compared to the predictive model. The different candidate models may also be built differently by selecting different training data.

Then, the server computer can evaluate the performance of the plurality of candidate models 270 based on the results associated with the new set of previous requests and the stored results associated with the stored set of historical requests. In some embodiments, the candidate models 270 may be evaluated using a hold-out sample. The server computer can select the predictive model to be used as an operational model (e.g., final model) based on the predictive model having a higher evaluated performance compared to other candidate models of the plurality of candidate models. In some embodiment, more than one final model 280 may be selected from the candidate models 270 based on their evaluated performed (e.g., the most accurate predictions based on the training sample).

The modeling behavior tree 230 can control the settings and parameters for building the models. For example, the modeling behavior tree 230 can determine which types of algorithms to use, the number of models to build, the amount of time or number of iterations used to build the model, and any initialization parameters for the machine learning algorithm. In one embodiment, the community detection algorithm is a K-means clustering algorithm, the optimization algorithm is an Ant Colony algorithm, the smoothing algorithm is based on vector distance, the supervised machine learning algorithm is a gradient boosting machine, and the learner for generating the decision rules is an ensemble Prim's algorithm. In another embodiment, the community detection algorithm is a restricted Boltzmann machine, the optimization algorithm is an Ant Colony algorithm, the smoothing algorithm uses an artificial neural network, the supervised machine learning algorithm is a gradient boosting machine, and the learner for generating the decision rules is an ensemble Prim's algorithm. In another embodiment, the community detection algorithm is a based on IPCA, the optimization algorithm is an Ant Colony algorithm, the smoothing algorithm uses an artificial neural network, the supervised machine learning algorithm is a gradient boosting machine, and the learner for generating the decision rules is an ensemble Prim's algorithm. Other combinations of algorithms may be used.

In some embodiments, the model building process can end if the model has not changed, thereby preventing the model from becoming overfit. For example, the server computer can determine whether the current predictive model is different from a stored model. The difference can be based on a similarity threshold value. For example, the current predictive model may not provide scores on the training data that are different from the scores of the stored model based on the similarity threshold value. The stored model may be one that was previously built by the server computer. The next step in the model building process, the generating of the decision rules using the predictive model, may be performed based on the determination that the predictive model is different from the stored model. If the predictive model is not different, the model building process can be stopped until new requests are received.

G. Decision Rule Generation

The model 280 may provide a continuous score for a given input (e.g., request or sample), but may not provide any decision making based on the score. In order to provide decision making, a leaner (e.g., a machine learning algorithm) can be used to determine, at 208, a decision rule (e.g., a binary decision, such as Yes or No) for different scores output by the model based on predetermined goals and criteria. The server computer can generate a set of binary decision rules using the predictive model and the topological graph. The binary decision rules can set a threshold value for a continuous score determined by the predictive model.

The decision rules 290 can be determined using a combination of goals (e.g., a signal to noise ratio). The decision rules 290 can set scoring threshold values based on the distribution of the scores of the model across the training sample. For example, the decision rules 290 can set a scoring threshold values for determining whether an authentication request is fraudulent or not-fraudulent. In some embodiments, the learner can include multiple learners where single rules are generated by finding overlapping decision rule sets across learners. In some embodiments, if the model 280 is rebuilt using different training data, thereby causing a shift in the distribution of scores, the decision rules 290 can be re-determined.

In building the set of binary decision rules, the learner can determine a minimum spanning tree (the subset of edges having the least weight to connect all nodes) from the topological graph. To build the minimum spanning tree, the learner may pick an arbitrary starting node and adds it to an initial tree structure. Then it may determine the edge from the starting node with the least weight. This edge and the connecting node are added to the tree structure. Then the node that is connected to tree, and is not already within the tree structure, and that is connected by an edge having the least weight, is added to the tree structure. This process is repeated until all nodes in the graph or subgraph are in the minimum spanning tree. This resulting minimum spanning tree reduces the size and complexity of the graph while still being representative of its general structure, enabling a series of binary rules (questions) to be generated. The fifth graph 305 of FIG. 3 shows a binary decision rule. In some embodiments, the learner can use an ensemble of Prim's algorithms to determine the rules based on a minimum spanning tree as further described below. Further details of the Prim's algorithm are described in Prim RC. “Shortest connection networks and some generalizations.” Bell System Technical Journal, 1957, 36:1389-401.

H. Optimizing the Model Building Process

After the model 280 and associated decision rules 290 are built, the server computer can update the modeling behavior tree, to obtain an optimized modeling behavior tree, based on the evaluated performance of the predictive model. As discussed above, the modeling behavior tree sets parameters for initializing the community detection algorithm, the optimization algorithm, and the supervised machine learning algorithm. The modeling behavior tree can be optimized using a learner (e.g., the Ant Colony optimization algorithm) that analyzes the outcomes 295 from the algorithms (e.g., the community detection algorithm, optimization algorithm, and smoothing algorithm) used in the model building process to tune the modeling behavior tree 230. The learner can add or remove information, and change AI settings or parameters, to optimize the model building process as shown in the sixth graph 306 of FIG. 3.

After obtaining the optimized modeling behavior tree, the server computer can build a second predictive model using the optimized modeling behavior tree. In building the second predictive model, the community detection algorithm, the optimization algorithm, and the supervised machine learning algorithm are initialized using optimized parameters set by the optimized modeling behavior tree. The second predictive model may provide more accurate predictions than the previous predictive model for the training sample.

As such, the modeling behavior tree 280 that is used to automate the model building process can perform self-correction by adjusting the settings and parameters used by the other AIs based on the performance of the model 290. For example, if the novel structures created by the optimization algorithm increased the accuracy of the resulting model, then the weighting of novel structures can be increased for the next rebuild of the model. On the other hand, if the novel structures decreased the accuracy of the resulting model, they can be weighted less or be removed in the next model rebuild. This self-correction is advantageous because the parameters and settings used to run the algorithms are based on the incoming data, which can shift over time. By tuning the modeling behavior tree 280, the parameters and settings for the various algorithms can be updated to suit the different incoming data, thereby improving model performance in later builds.

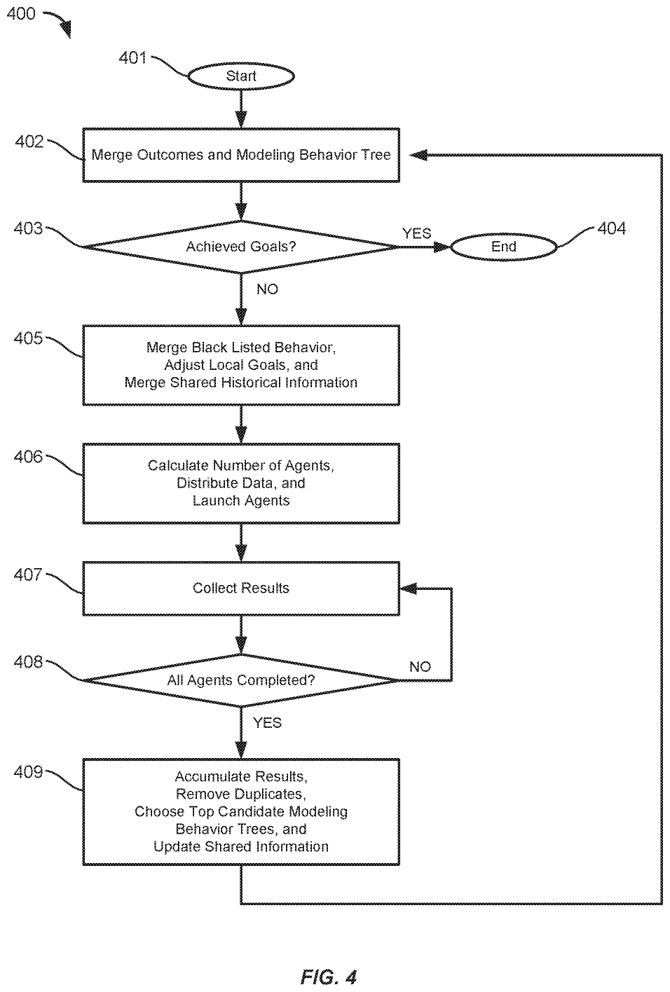

FIG. 4 shows a flow chart 400 of a method for optimizing the model building process, in accordance with some embodiments. The method for optimizing the model building process can be driven by an optimization behavior tree that uses an AI learner. The optimization behavior can include black listed behavior (e.g., greater than two years of data, or a choice point that is not achievable) and settings and parameters for the AI learner (e.g., number of hive mind agents). The AI learner may operate similar to the Ant Colony optimization algorithm.

The method for optimizing the model building process starts, at 401, with merging the modeling behavior tree with outcomes and historical modeling behavior trees at 402. Then, at 403, the method determines whether predetermined goals have been achieved. The goals can be based on the evaluated performance of the predictive model build using the modeling behavior tree. If the predetermined goals are met (YES at 403), then the method ends, at 404, since there is no need to optimize the model building process.

If the predetermined goals are not met (NO at 403), then the method for optimizing the model building process continues, at 405, to merge black listed behavior, adjust local goals, and merge shared historical information. The shared historical information can be stored at the server computer that builds the models.

Then, at 406, the AI learner calculates a number of agents, distributes data, and launches the agents. At 407, the results from the agents are collected. The AI learner can determine whether all of the agents have completed at 408. If all of the agents have not completed yet (NO at 407), then the AI learner returns to collecting results at 407. If all of the agents are complete (YES at 408), then the AI learner continues the method, to 409, and accumulates the results, removes duplicates from the results, selects the top candidate modeling behavior trees from the results, and updates the shared historical information. The candidate modeling behavior trees can be selected to be used for the model building process. Thus, the model building process can be tuned such that it is self-correcting, as discussed above. Advantageously, the model building parameters are updated as the training data changes, thereby proving provide more accurate models.

I. Operation of The Model

After the model has been built and the set of decision rules has been generated, they may be used to perform decision making in an operational setting.

The server computer can load the predictive model into a system memory. The server computer can then receive a new request in real time. For example, the request may be received in a message from a client device sent over a network. In some embodiments, the server computer can extract or reformat the request to suit the model. Then, the server computer can apply the new request to the predictive model to obtain a request score. The server computer can then determine a decision based on the request score using the set of binary decision rules. The server computer can generate a response indicating the decision.

For example, a server computer can receive authentication requests and use the model and decision rules to grant or deny based on whether the model predicts that the authentication request is fraudulent or not-fraudulent. The decision making server may the same, or different, from the server computer that built the model.

### III. Monitoring for New Information to Rebuild the Model

The automated machine learning process of FIG. 2 can maintain and improve model performance through self-correction as discussed above. However, the risk of overfitting can increase the model that the model is rebuilt. For example, if the model is rebuilt on a strict schedule, even if the training sample has not changed significantly compared to prior builds, then the resulting model may correspond too closely to the training data and may not provide accurate predictions during later operational use.

To reduce or prevent the problem of overfitting, the automated machine learning model building process described above with respect to FIG. 2 can be monitored to determine whether the current model building process is based on new or different information compared to previous model building processes. The automated machine learning model building process may continue if or and different information has been generated (e.g., new or different nodes and edges in the topological graph, new or different community structures, new or different new inferred edges in the graph, new or different inferred community structures, or a new or different model). If new or different information has not been created compared to previous model building processes, then the current model building process may be canceled and monitoring of the information may resume. Accordingly, a new model and associated decision rules are only built when they are based on new and different information, reducing or preventing the problem of overfitting. In addition, the monitoring process can reduce the amount of computing resources expended during for model building since the model building process can be ended early if there is no new information.

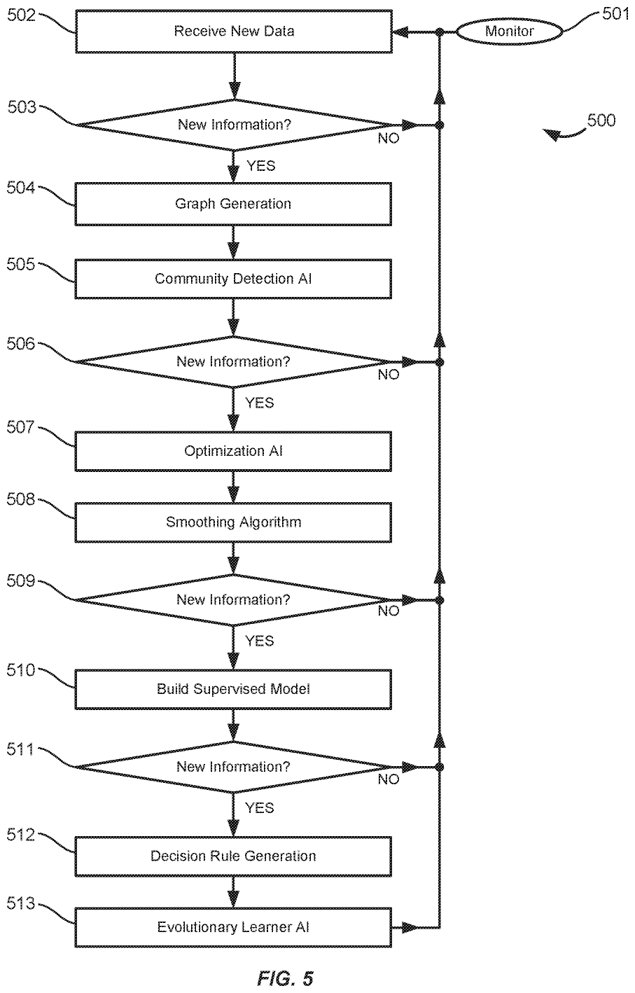

FIG. 5 shows a flow chart 500 of a method for monitoring a model building process, in accordance with some embodiments. The monitoring method can be applied to the automated machine learning model building process described above with respect to FIG. 2, the model building process described above with respect to FIG. 1, and any other suitable machine learning model building process.

At 501, the monitoring process begins. The monitoring process can be performed by the same server computer, or cluster of server computers, that perform the model building process. The monitoring process may be run continually as a background process. At 502, new data or records are received, which can be used as training data for the model. The new data can be stored in data storage as discussed above. At 503, the monitoring process can determine whether the data storage (e.g., the training data) contains new or different information. For example, the monitoring process can track the number of new data records received and determine whether the number is greater than a predetermined threshold. If the monitor process determines that there is not new data available as training data, indicating that there is no new information (NO at 503), then the monitor process returns to receiving more new data at 502.

If the monitor process determines that there is new data available as training data, indicating that there is new information (YES at 503), the then model building process continues to generate a topological graph, at 504, based on the new data. The topological graph can be generated according to the methods discussed above. After generating the topological graph, a community detection algorithm can determine new communities structures within the topological graph, at 505, as discussed above. After the new/current community structures have been generated, the monitoring process can determine a percentage difference between the new community structures compared to previously determined community structures used in prior model builds, which can be stored and associated with their corresponding models. The percentage difference between the new and old community structures can be based on whether nodes have been added or removed from communities, whether an entire communities have been added or removed, or whether certain communities overlap more or less with other communities, for example. In some embodiments, the percentage difference can be determined using graph similarity measures based on the nodes within the communities. If the percentage difference between the new community structures and the previously determined community structures is less than a predetermined threshold value, indicating that there is no new information (NO at 506), then the monitor process returns to receiving more new data at 502.

If the percentage difference between the new community structures and the previously determined community structures is greater than a predetermined threshold value, indicating that there is new information (YES at 506), then the model building process continues to run the optimization algorithm at 507, which can infer community structures within the topological graph as discussed above. After the inferred community structures are determined, the model building process can continue to perform a smoothing algorithm on the topological graph, at 508, as discussed above. After the topological graph has been smoothed, the monitoring process can determine a percentage difference between the new/current topological graph compared to the smoothed topological graphs used in prior model builds, which can be stored and associated with their corresponding models. In some embodiments, the percentage difference can be determined using graph similarity measures based on the nodes within the smoothed topological graph and the prior, old (e.g., stored) topological graphs used in a prior model build. If the percentage difference between the new and old smoothed topological graph structures is less than a predetermined threshold value, indicating that there is no new information (NO at 509), then the monitor process returns to receiving more new data at 502.

If the percentage difference between the new and old smoothed topological graph structures is greater than a predetermined threshold value, indicating that there is new information (YES at 509), then the model building process continues to build the model at 510. The model can be built using a supervised machine learning algorithm as discussed above. In some embodiments, several candidate models and built and the best performing models from among the candidate models are selected to be the final models, as discussed above. Then the new/current model can be validated using the stored data records. After the model has been validated, the monitoring process can determine a percentage difference between the new/current model compared to prior models. In some embodiments, the percentage difference can be based on a difference between the scores of the model on the training data compared to the scores of a prior model on the same training data. If the percentage difference between the new and prior models is less than a predetermined threshold value, indicating that there is no new information (NO at 511), then the monitor process returns to receiving more new data at 502.

If the percentage difference between the new and old models is greater than a predetermined threshold value, indicating that there is new information (YES at 511), then the model building process continues to generate decision rules corresponding to the new model, at 512, as discussed above. Then the modeling behavior tree used to drive the model building process can be tuned using the

Evolutionary Learner AI, at 513, as discussed above. Then the monitor process returns to receiving more new data at 502 and continues monitoring the model building process. In some embodiments, certain steps of the monitoring process may be rearranged or removed.

Thus, the monitoring process stops the model building process early if there is no new information. Stopping the model building process early is advantageous because it reduces the amount of computing resources spent on the model building process in situations where the resulting model might not provide better, or different, performance given that is based on the same information as before. In addition, the monitoring process prevents the model from becoming overfit by only rebuilding the model when the underlying training data is different enough to warrant it.

### IV. Exemplary Use Cases

The automated machine learning process discussed above can be used in building any suitable machine learning model. For example, the automated machine learning can be implemented in an authentication/data security hub that uses machine learning models in processing and routing authentication request messages as part of automated privacy control, automated request modification, and automated third party evaluation, as further described below.

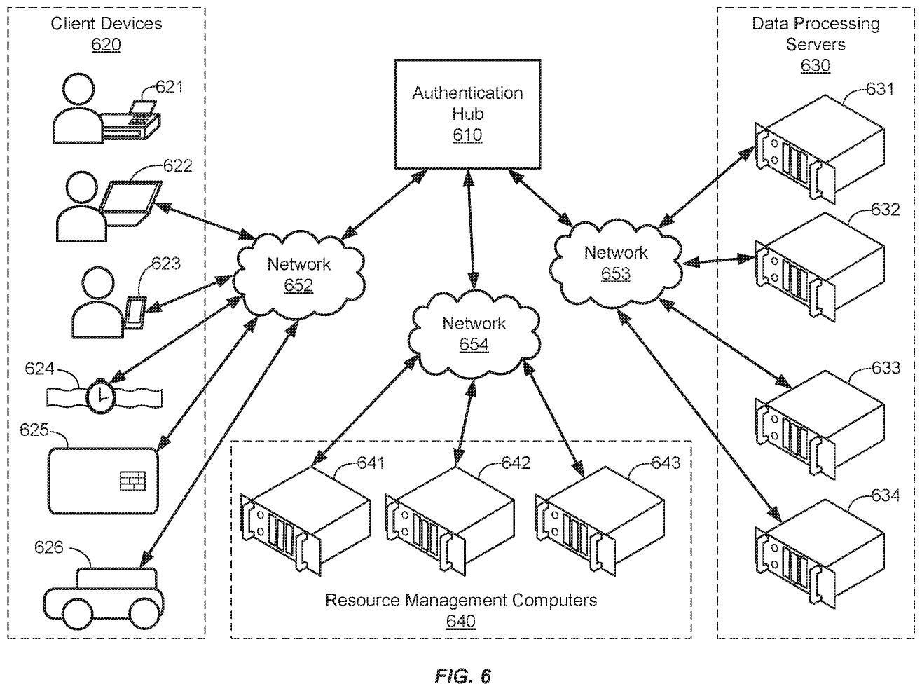

FIG. 6 shows a system diagram of an authentication hub 610 in communication with client devices 620, data processing servers 630, and resource management computers 640, in accordance with some embodiments. The client devices 620 can include any device that requests access to a resource being managed by one of the resource management computers 640. For example, a client device could be a point of sale terminal 621, a personal computer 622, a mobile device 623, a wearable device 624, a smart card 625 (e.g., a biometric card or payment card), or a vehicle 626. Each of the client devices 620 can communicate with the authentication hub over a first network 652. The client devices 620 may communicate with the network 652 using a wired network connection (e.g., Ethernet) or a wireless network connection (e.g. Wi-Fi, cellular, or near field communications).

The client devices 620 can send authentication requests that include different types of authentication information and that are formatted differently. To communicate with the variety of different client devices 620 and handle the variety of different authentication request formats, the authentication hub 610 can include an automated client interface automatically adapts the authentication requests for processing. The client interface can be used for receiving authentication requests from the client devices 620 and for sending access responses to the client devices 620 over the first network 652.

The authentication hub 610 can also communicate with a plurality of data processing servers 630. Each of the data processing servers 630 may be capable of processing different types of authentication information. For example, a first data processing server 631 can evaluate one or more hardware identifiers of a client device in order to determine whether a particular client device is a security risk. A second data processing server 632 can determine use the network identifier (e.g., IP address) of the client device to determine whether a particular client device is a security risk. A third data processing server 633 can analyze biometric data (e.g., a finger print scan or a retina scan) of a user of a client device to determine whether it is associated with a registered user. A fourth data processing server 634 can analyze personal information of the user to determine whether it matches stored account information. The four data processing servers 630 described above are merely examples of the various data processing servers that could be in communication with the authentication hub 610. The authentication hub 640 may communicate with other data processing servers to process other types of authentication information.

To communicate with the variety of different data processing servers 630, the authentication hub 610 can include an automated client interface which automatically adapts the authentication requests for processing. The client interface can be used for receiving authentication requests from the client devices 620 and for sending access responses to the client devices 620 over the first network 652.

The authentication hub 610 can provide a data processor interface for communicating with the data processing servers 630 over a second network 653. The data processor interface can be used for making authentication requests to the data processing servers 630 and receiving authentication responses from the data processing servers 630 over the second network 653.

The authentication hub 610 can also communicate with a plurality of resource management computers 640. Each of the resource management computers may manage a different type of resource. For instance, a first resource management computer 641 may manage user accounts for a website, a second resource management computer 642 can manage academic resources for a school district, and a third resource management computer 643 can manage payment accounts and provide authorization of payment transactions. The three resource management computers 640 described above are merely examples of the various data processing servers that could be in communication with the authentication hub 610. The authentication hub 640 may communicate with other data processing servers to process other types of authentication information.

The authentication hub 610 can provide a resource manager interface for communicating with the resource management computers 640 over a third network 654. The resource management interface can be used for sending authentication requests to the resource management computers 640 and receiving access responses from the resource management computers 640 over the third network 654.

A. Automated Privacy Control

The authentication hub 610 can perform automated privacy control to prevent excessive amounts of sensitive authentication information from being distributed to data processing servers or other third parties. By restricting the type and amount of sensitive information used for authentication, the authentication hub can reduce the risk of such information being intercepted or leaked (e.g., due to a security breach at one of the data processing servers).

As part of automated privacy control, the authentication hub can determine that more, or less, authentication information is required to authenticate a client device depending on various factors. For example, the authentication hub 610 can determine that less authentication information is required in order to authenticate a client device having a higher trust level compared to a client device having a lower trust level. In addition, the authentication hub 610 can determine that more authentication information is required to authenticate a client device that is requesting resources having a higher resource security level (e.g., a greater amount of resources or a more sensitive type of resource) compared to one requesting resources having a lower security level (e.g., fewer resources or a less sensitive type of resource). The authentication hub 610 can also assign weights to different types of authentication information such that it has more or less authentication information is needed to validate the client device depending on what type of authentication information is available.

The authentication hub 610 can provide the automated privacy control described above through the use of an ensemble AI model. The AI model can determine an authentication level, and the types and amounts of authentication information that would meet that authentication level, based on the trust level of the client device, the sensitivity of the authentication information, and the security level of the requested resource. The AI model used for automated privacy control can be improved using the automated machine learning process described above.

In addition, the authentication hub 610 use an AI model to determine which a particular client devices is exhibiting suspicious activity indicative of a security breach. Upon such a determination, the authentication hub 610 can send a signal to the client device commanding it to clear its cache in order to preserve security of sensitive information. The client device behavior can be analyzed using a distributed graph learner (e.g., a distributed Prim's algorithm). The AI model used for modeling client behavior can be improved using the automated machine learning process described above.

B. Automated Request Modification

The authentication hub 610 can also perform automated request modification. For example, the authentication hub can append additional information stored at the authentication hub to the authentication request. The additional information may enable a particular data processing server to be capable of handling the authentication request. For example, if the authentication hub 610 has stored a hardware identifier for a particular client device from past authentication requests, and the data processing server would use the hardware identifier for authentication, then the authentication hub 610 can add the hardware identifier to the authentication request sent to the data processing server, even if the client device did not include the hardware identifier in the authentication request that is currently being processed.

The authentication hub can provide automated request modification through the use of another ensemble AI model. The AI model can determine a mapping of the information required particular data processing server to the information of the authentication request and any stored additional information that could be used to modify the authentication request. The AI model for automated request modification can be built and tuned using the automated machine learning process described above.

C. Automated Third Party Evaluation

The authentication hub 610 can also perform automated third party evaluation (e.g., evaluation of the data processors). For example, the authentication hub can evaluate the capabilities, authentication information requirements, exposure level, network condition, stability, accuracy, of each data processing server. An AI model can be used to determine whether a third party has had their security breached based on these measurements. For example, community detection algorithm (e.g., IPCA or hyper IPCA), can be used to classify exposure levels of each data processor and determine community groups among the data processors. The authentication hub 610 can then use the AI model output in determining which data processing server to route an authentication request message to. The AI used by the authentication hub 610 to select a particular data processing server to send the authentication request to can be built and tuned using the automated machine learning process described above.

### V. Exemplary Method

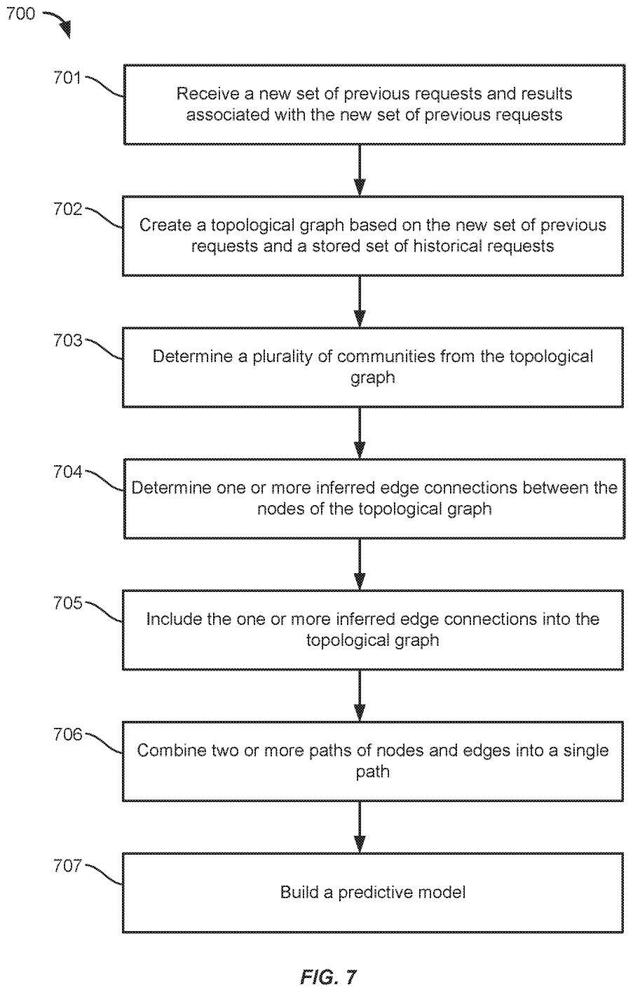

FIG. 7 shows a flowchart 700 of an automated process for building a machine learning model, in accordance with some embodiments. The method can be performed by the server computer discussed above with respect to FIG. 2.

The method can include a step 701 of receiving a new set of previous requests and results associated with the new set of previous requests.

The method can further include a step 702 of creating a topological graph based on the new set of previous requests and a stored set of historical requests. The topological graph can include nodes and edges connecting the nodes.

The method can further include a step 703 of determining a plurality of communities from the topological graph using a community detection algorithm. Each community of the plurality of communities can include a subset of the nodes.

The method can further include a step 704 of determining one or more inferred edge connections between the nodes of the topological graph using an optimization algorithm. The one or more inferred edge connections can reduce a cost function based on the results associated with the new set of previous requests and stored results associated with the stored set of historical requests.

The method can further include a step 705 of including the one or more inferred edge connections into the topological graph.

The method can further include a step 706 of combining two or more paths of nodes and edges into a single path based on a commonality of the two or more paths to obtained a smoothed topological graph.

The method can further include a step 707 of building a predictive model based on the smoothed topological graph using a supervised machine learning algorithm, the plurality of communities, the results associated with the new set of previous requests, and the stored results associated with the stored set of historical requests.

In some embodiments, the method can further include a step of generating a set of binary decision rules using the predictive model and the topological graph. The binary decision rules can set a threshold value for a continuous score determined by the predictive model.

In some embodiments, the method can further include a step of loading the predictive model into a system memory of a server computer. The method can also include steps for receiving, by the server computer, a new request in real time, applying the new request to the predictive model to obtain a request score, and determining a decision based on the request score using the set of binary decision rules. The method can also include a step of generating a response indicating the decision.

In some embodiments, the method can further include a step of evaluating a performance of predictive the model based on the results associated with the new set of previous requests and stored results associated with the stored set of historical requests. The method can also include a step of updating a modeling behavior tree to obtain an optimized modeling behavior tree based on the evaluated performance of the predictive model. The modeling behavior tree can set parameters for initializing the community detection algorithm, the optimization algorithm, and the supervised machine learning algorithm.

In some embodiments, the method can further include building a second predictive model using the optimized modeling behavior tree. In building the second predictive model, the community detection algorithm, the optimization algorithm, and the supervised machine learning algorithm are initialized using optimized parameters set by the optimized modeling behavior tree.

In some embodiments, the method can further include determining that the plurality of communities are different from a stored plurality of communities associated with a stored model. In such embodiments, the determination of the one or more inferred edge connections is performed based on the determination that the plurality of communities are different from the stored plurality of communities.

In some embodiments, the method can further include determining that the smoothed topological graph is different from a stored topological graph associated with a stored model. In such embodiments, the building of the predictive model is performed based on the determination that the smoothed topological graph is different from the stored topological graph.

In some embodiments, the method can further include determining that the predictive model is different from a stored model and generating a set of binary decision rules using the predictive model, the generation of the set of binary decision rules being performed based on the determination that the predictive model is different from the stored model.

In some embodiments, the method can further include building a plurality of candidate models based on the smoothed topological graph using the supervised machine learning algorithm, the candidate models including the predictive model. In such embodiments, the method can further include evaluating the performance of the plurality of candidate models based on the results associated with the new set of previous requests and stored results associated with the stored set of historical requests. The method can further include selecting the predictive model to be used as an operational model based on the predictive model having a higher evaluated performance compared to the other candidate models of the plurality of candidate models.

In some embodiments, the community detection algorithm is a K-means clustering algorithm, the optimization algorithm is an Ant Colony algorithm, and the supervised machine learning algorithm is a gradient boosting machine.

### VI. Exemplary Computer System

The various entities and elements described herein may operate one or more computer apparatuses to facilitate the functions described herein. Any of the elements in the above-described figures, including any computer servers or databases, may use any suitable number of subsystems to facilitate the functions described herein.

Such subsystems or components are interconnected via a system bus. Subsystems may include a printer, keyboard, fixed disk (or other memory comprising computer readable media), monitor, which is coupled to display adapter, and others. Peripherals and input/output (I/O) devices, which couple to an I/O controller (which can be a processor or other suitable controller), can be connected to the computer system by any number of means known in the art, such as a serial port. For example, a serial port or an external interface can be used to connect the computer apparatus to a wide area network such as the Internet, a mouse input device, or a scanner. The interconnection via the system bus allows the central processor to communicate with each subsystem and to control the execution of instructions from system memory or the fixed disk, as well as the exchange of information between subsystems. The system memory and/or the fixed disk may embody a computer readable medium.

As described, the embodiments may involve implementing one or more functions, processes, operations or method steps. In some embodiments, the functions, processes, operations or method steps may be implemented as a result of the execution of a set of instructions or software code by a suitably-programmed computing device, microprocessor, data processor, or the like. The set of instructions or software code may be stored in a memory or other form of data storage element which is accessed by the computing device, microprocessor, etc. In other embodiments, the functions, processes, operations or method steps may be implemented by firmware or a dedicated processor, integrated circuit, etc.

It should be understood that any of the embodiments can be implemented in the form of control logic using hardware (e.g. an application specific integrated circuit or field programmable gate array) and/or using computer software with a generally programmable processor in a modular or integrated manner. As used herein, a processor refers to one or more processors. A processor may be a single-core processor, multi-core processor on a same integrated chip, or multiple processing units on a single circuit board or networked. Based on the disclosure and teachings provided herein, a person of ordinary skill in the art will know and appreciate other ways and/or methods to implement embodiments of the present invention using hardware and a combination of hardware and software.

Any of the software components or functions described in this application may be implemented as software code to be executed by a processor, or more than one processor, using any suitable computer language such as, for example, Java, C, C++, C #, Objective-C, Swift, or scripting language such as Perl or Python using, for example, conventional or object-oriented techniques. The software code may be stored as a series of instructions or commands on a computer readable medium for storage and/or transmission. A suitable non-transitory computer readable medium can include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Storage media and computer-readable media for containing code, or portions of code, can include any appropriate media known or used in the art, including storage media and communication media, such as but not limited to volatile and non-volatile, removable and non-removable media implemented in any method or technology for storage and/or transmission of information such as computer-readable instructions, data structures, program modules, or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices, data signals, data transmissions, or any other medium which can be used to store or transmit the desired information and which can be accessed by the computer. Based on the disclosure and teachings provided herein, a person of ordinary skill in the art will appreciate other ways and/or methods to implement the various embodiments.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g. a hard drive, a CD, or an entire computer system), and may be present on or within different computer products within a system or network. A computer system may include a monitor, printer, or other suitable display for providing any of the results mentioned herein to a user.

Any of the methods described herein may be totally or partially performed with a computer system including one or more processors, which can be configured to perform the steps. Thus, embodiments can be directed to computer systems configured to perform the steps of any of the methods described herein, potentially with different components performing a respective steps or a respective group of steps. Although presented as numbered steps, steps of methods herein can be performed at a same time or in a different order. Additionally, portions of these steps may be used with portions of other steps from other methods. Also, all or portions of a step may be optional. Additionally, any of the steps of any of the methods can be performed with modules, units, circuits, or other means for performing these steps.

The specific details of particular embodiments may be combined in any suitable manner without departing from the spirit and scope of embodiments of the invention. However, other embodiments of the invention may be directed to specific embodiments relating to each individual aspect, or specific combinations of these individual aspects.

The above description of example embodiments has been presented for the purposes of illustration and description. The scope of the embodiments may, therefore, be determined not with reference to the above description, but instead may be determined with reference to the pending claims along with their full scope or equivalents.

A recitation of “a,” “an” or “the” is intended to mean “one or more” unless specifically indicated to the contrary. The use of “or” is intended to mean an “inclusive or,” and not an “exclusive or” unless specifically indicated to the contrary. The use of the terms “first,” “second,” “third,” “fourth,” “fifth,” “sixth,” “seventh,” “eighth,” “ninth,” “tenth,” and so forth, does not necessary indicate an ordering or a numbering of different elements and may simply be used for naming purposes to clarify distinct elements. The use of “client” computer and “server” computer does not necessary indicate the intended use of the computers, but may simply be used for naming purposes.

All patents, patent applications, publications, articles, and descriptions mentioned herein are incorporated by reference in their entirety for all purposes. None is admitted to be prior art.

What is claimed is:

1. A computer system for building machine learning models, the computer system comprising:
a system memory;
one or more processors; and
a computer readable storage medium storing instructions that, when executed by the one or more processors, cause the one or more processors to:
receive a new set of previous requests and results associated with the new set of previous requests,
create a topological graph based on the new set of previous requests and a stored set of historical requests, the topological graph including nodes and edges connecting the nodes,
determine a plurality of communities from the topological graph using a community detection algorithm, each community of the plurality of communities including a subset of the nodes,
determine one or more inferred edge connections between the nodes of the topological graph using an optimization algorithm, the one or more inferred edge connections reducing a cost function based on the results associated with the new set of previous requests and stored results associated with the stored set of historical requests,
including the one or more inferred edge connections into the topological graph,
combine two or more paths of nodes and edges into a single path based on a commonality of the two or more paths to obtained a smoothed topological graph,
build a predictive model based on the smoothed topological graph using a supervised machine learning algorithm, the plurality of communities, the results associated with the new set of previous requests, and the stored results associated with the stored set of historical requests.

2. The computer system of claim 1, wherein the instructions, when executed by the one or more processors, further cause the one or more processors to:
generate a set of binary decision rules using the predictive model and the topological graph, the binary decision rules setting a threshold value for a continuous score determined by the predictive model.

3. The computer system of claim 2, wherein the instructions, when executed by the one or more processors, further cause the one or more processors to:
load the predictive model and the set of binary decision rules into the system memory,
receive a new request in real time,
apply the new request to the predictive model to obtain a request score,
determine a decision based on the request score using the set of binary decision rules, and
generate a response indicating the decision.

4. The computer system of claim 1, wherein the instructions, when executed by the one or more processors, further cause the one or more processors to:
evaluate a performance of the predictive model based on the results associated with the new set of previous requests and stored results associated with the stored set of historical requests, and
update a modeling behavior tree to obtain an optimized modeling behavior tree based on the evaluated performance of the predictive model, the modeling behavior tree setting parameters for initializing the community detection algorithm, the optimization algorithm, and the supervised machine learning algorithm.

5. The computer system of claim 4, wherein the instructions, when executed by the one or more processors, further cause the one or more processors to:
build a second predictive model using the optimized modeling behavior tree, wherein the community detection algorithm, the optimization algorithm, and the supervised machine learning algorithm are initialized using optimized parameters set by the optimized modeling behavior tree.

6. The computer system of claim 1, wherein the instructions, when executed by the one or more processors, further cause the one or more processors to:
determine that the plurality of communities are different from a stored plurality of communities associated with a stored model, wherein the determination of the one or more inferred edge connections is performed based on the determination that the plurality of communities are different from the stored plurality of communities.

7. The computer system of claim 1, wherein the instructions, when executed by the one or more processors, further cause the one or more processors to:
determine that the smoothed topological graph is different from a stored topological graph associated with a stored model, wherein the building of the predictive model is performed based on the determination that the smoothed topological graph is different from the stored topological graph.

8. The computer system of claim 1, wherein the instructions, when executed by the one or more processors, further cause the one or more processors to:
determine that the predictive model is different from a stored model, and
generate a set of binary decision rules using the predictive model, the generation of the set of binary decision rules being performed based on the determination that the predictive model is different from the stored model.

9. The computer system of claim 1, wherein the instructions, when executed by the one or more processors, further cause the one or more processors to:
build a plurality of candidate models based on the smoothed topological graph using the supervised machine learning algorithm, the plurality of candidate models including the predictive model,
evaluate a performance of each of the plurality of candidate models based on the results associated with the new set of previous requests and the stored results associated with the stored set of historical requests, and
select the predictive model to be used as an operational model based on the predictive model having a higher evaluated performance compared to other models of the plurality of candidate models.

10. The computer system of claim 1, wherein the community detection algorithm is a K-means clustering algorithm, the optimization algorithm is an Ant Colony algorithm, and the supervised machine learning algorithm is a gradient boosting machine.

11. A method for building machine learning models, the method comprising:
receiving a new set of previous requests and results associated with the new set of previous requests,
creating a topological graph based on the new set of previous requests and a stored set of historical requests, the topological graph including nodes and edges connecting the nodes,
determining a plurality of communities from the topological graph using a community detection algorithm, each community of the plurality of communities including a subset of the nodes,
determining one or more inferred edge connections between the nodes of the topological graph using an optimization algorithm, the one or more inferred edge connections reducing a cost function based on the results associated with the new set of previous requests and stored results associated with the stored set of historical requests,
including the one or more inferred edge connections into the topological graph,
combining two or more paths of nodes and edges into a single path based on a commonality of the two or more paths to obtained a smoothed topological graph,
building a predictive model based on the smoothed topological graph using a supervised machine learning algorithm, the plurality of communities, the results associated with the new set of previous requests, and the stored results associated with the stored set of historical requests.

12. The method of claim 11, further comprising:
generating a set of binary decision rules using the predictive model and the topological graph, the binary decision rules setting a threshold value for a continuous score determined by the predictive model.

13. The method of claim 12, further comprising:
loading the predictive model into a system memory of a server computer,
receiving, by the server computer, a new request in real time,
applying the new request to the predictive model to obtain a request score,
determining a decision based on the request score using the set of binary decision rules, and
generating a response indicating the decision.

14. The method of claim 11, further comprising:
evaluating a performance of the predictive model based on the results associated with the new set of previous requests and stored results associated with the stored set of historical requests, and
updating a modeling behavior tree to obtain an optimized modeling behavior tree based on the evaluated performance of the predictive model, the modeling behavior tree setting parameters for initializing the community detection algorithm, the optimization algorithm, and the supervised machine learning algorithm.

15. The method of claim 14, further comprising:
building a second predictive model using the optimized modeling behavior tree, wherein the community detection algorithm, the optimization algorithm, and the supervised machine learning algorithm are initialized using optimized parameters set by the optimized modeling behavior tree.

16. The method of claim 11, further comprising:
determining that the plurality of communities are different from a stored plurality of communities associated with a stored model, wherein the determination of the one or more inferred edge connections is performed based on the determination that the plurality of communities are different from the stored plurality of communities.

17. The method of claim 11, further comprising:
determining that the smoothed topological graph is different from a stored topological graph associated with a stored model, wherein the building of the predictive model is performed based on the determination that the smoothed topological graph is different from the stored topological graph.

18. The method of claim 11, further comprising:
determining that the predictive model is different from a stored model, and
generating a set of binary decision rules using the predictive model, the generation of the set of binary decision rules being performed based on the determination that the predictive model is different from the stored model.

19. The method of claim 11, further comprising:
building a plurality of candidate models based on the smoothed topological graph using the supervised machine learning algorithm, the plurality of candidate models including the predictive model,
evaluating a performance of each of the plurality of candidate models based on the results associated with the new set of previous requests and the stored results associated with the stored set of historical requests, and
selecting the predictive model to be used as an operational model based on the predictive model having a higher evaluated performance compared to other models of the plurality of candidate models.

20. The method of claim 11, wherein the community detection algorithm is a K-means clustering algorithm, the optimization algorithm is an Ant Colony algorithm, and the supervised machine learning algorithm is a gradient boosting machine.
